(19) United States
(12) Patent Application Publication
(10) Pub. No.: US 2004/0195033 A1
(43) Pub. Date: Oct. 7, 2004

(54) Mounting structure for vehicle

(76) Inventor: Ki-Chang Kim, Gyeonggi-do (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/716,740

(22) Filed: Nov. 17, 2003

(30) Foreign Application Priority Data
Apr. 4, 2003 (KR) 2003-21268

(51) Int. Cl. B60K 5/12

(52) U.S. Cl. 180/291

(57) ABSTRACT

A mounting structure for a vehicle firmly and stably supports an engine or a transmission at a lateral side of an engine room by using a chassis bracket and a mounting bracket, thereby effectively minimizing vibration transfer from the engine or the transmission to the car body.

### CROSS-REFERENCE TO RELATED APPLICATIONS

This application claims priority of Korean Application No. 10-2003-0021268, filed on Apr. 4, 2003, the disclosure of which is incorporated fully herein by reference.

### FIELD OF THE INVENTION

The present invention relates to a mounting structure for installation of a heavy component, such as an engine or a transmission, to a lateral side of an engine room in a vehicle.

### BACKGROUND OF THE INVENTION

In general, an engine or a transmission of a vehicle is heavy in weight and generates vibration, such that it should be firmly and stably fixed to a vehicle body or frame. Furthermore, the heavy components, such as the engine or transmission, should be installed in a particular state to prevent vibration from being transmitted to the vehicle body.

### SUMMARY OF THE INVENTION

Embodiments of the present invention provide a simplified mounting structure of a vehicle configured to firmly and stably support an engine or a transmission at a lateral side of an engine room. The mounting structure is further constructed to stabilize vibration emitted from the engine or transmission and minimize its transfer to the vehicle body.

In accordance with a preferred embodiment of the present invention, a mounting structure comprises a mount having a vibration insulating member made of a rubber material between an inner pipe and an outer pipe. A chassis bracket integrally coupled to the outer pipe attaches the mount to a lateral side of the engine room to allow the longitudinal direction of the inner pipe and the outer pipe to correspond with the forward and rearward direction of the vehicle. A mounting bracket provides vertical walls in the forward and rearward direction of the mount of the car body to be coupled with the mount via a bolt which passes through the vertical walls and the inner pipe, wherein a coupling part integrally coupled with the vertical walls is fixed to a heavy component of the vehicle.

### BRIEF DESCRIPTION OF THE DRAWINGS

For fuller understanding of the nature and objects of the present invention, reference should be made to the following detailed description taken in conjunction with the accompanying drawings in which:

FIG. 1 is an exploded perspective view illustrating a mounting structure of a vehicle according to an embodiment of the present invention; and

FIG. 2 illustrates an assembly process of a mounting structure of a vehicle according to an embodiment of the present invention.

### DETAILED DESCRIPTION OF THE INVENTION

The preferred embodiment of the present invention will now be described in detail with reference to the accompanying drawings.

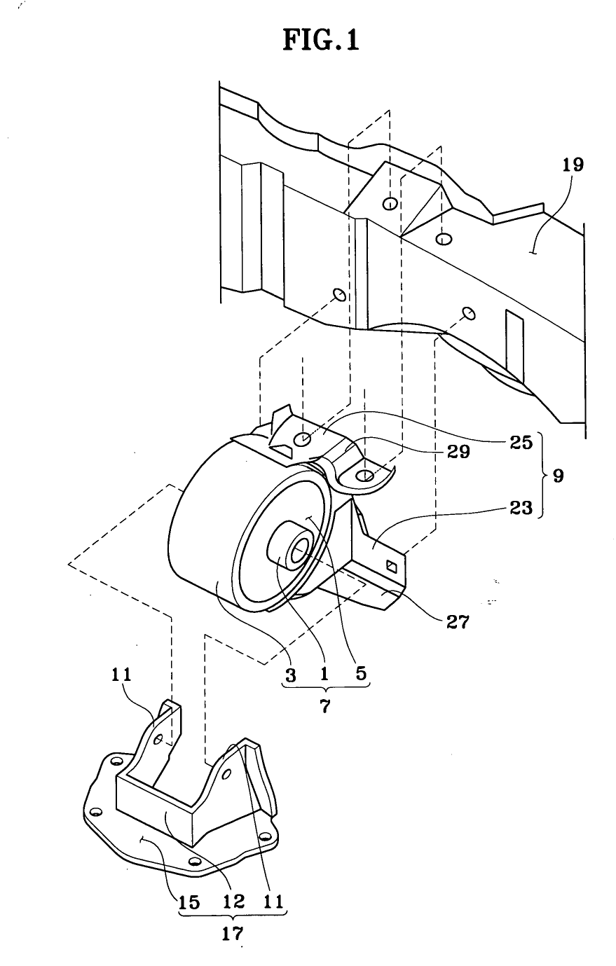

As shown in FIG. 1, a mount 7 has a vibration insulating member 5 between an inner pipe 1 and an outer pipe 3. A chassis bracket 9 integrally coupled with the outer pipe 3 attaches the mount 7 to a lateral side of the engine room to allow the longitudinal direction of the inner pipe 1 and the outer pipe 3 to correspond with the forward and rearward direction of the vehicle. A mounting bracket 17 provides vertical walls 11 in the forward and rearward direction of the mount 7 of the car body to be coupled with the mount 7 via a bolt 13 passing through the vertical walls 11 and the inner pipe 1, wherein a coupling part 15 integrally coupled with the vertical walls 11 is attached to a heavy component of the vehicle.

The inner pipe 1 and the outer pipe 3 of the mount 7 are connected to each other via the vibration insulating member 5 whereby vibration is insulated therebetween. The inner pipe 1 is connected to a vehicle heavy component such as an engine or a transmission, while the outer pipe 3 is connected to a lateral side of an engine room via the chassis bracket 9.

In an exemplary embodiment, the lateral side of the engine room coupled with the chassis bracket 9 refers to a side frame 19. In addition, the vehicle heavy component in the exemplary embodiment of the present invention is a transmission 21.

The chassis bracket 9 includes a vertical plate 23 having bolt holes and a vertical surface for being closely attached to the side frame 19. A horizontal plate 25 is formed with bolt holes and is horizontally formed for attachment to a lateral side of the engine room. As shown in the drawings, the vertical plate 23 and the horizontal plate 25 have a reinforcing rib 27 horizontally curved at the bottom side thereof and a bent part 29, respectively, to strengthen the rigidity thereof.

The mounting bracket 17 further includes a vertical wall connector 12 for connecting the vertical walls 11. The coupling part 15 is formed with a plurality of bolt holes and constitutes a horizontal plate that couples the bottom of the vertical walls 11 and the vertical wall connector 12 as one flat surface. The transmission 21 is integrally bolted to the mounting bracket 17 via bolts passing through the bolt holes integrally formed at the coupling part 15.

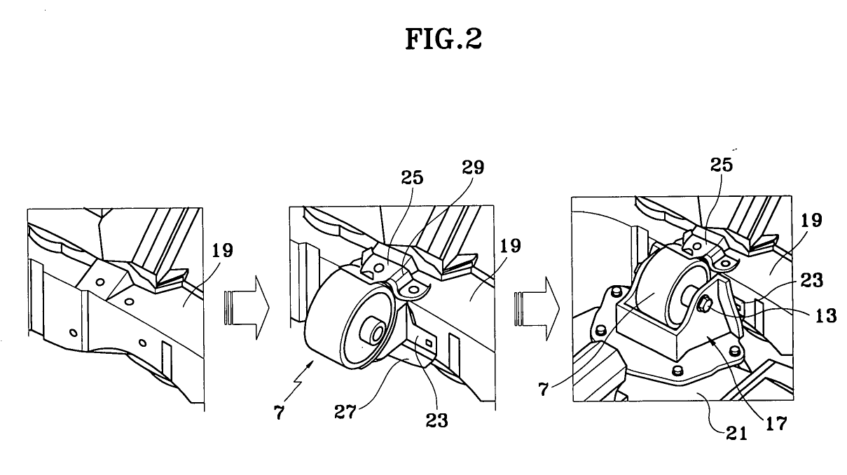

FIG. 2 illustrates an assembly process of a mounting structure according to FIG. 1. With reference to the left view of FIG. 2, the side frame 19 is formed with a plurality of bolt holes corresponding to the bolt holes of the horizontal plate 25 and the vertical plate 23.

As shown in the middle view of FIG. 2, the chassis bracket 9 formed with the vertical plate 23 and the horizontal plate 25 is integrated with the mount 7 for being secured at the side frame 19. Therefore, the mount 7 is fixed to the car body side by way of screwing bolts into a plurality of bolt holes formed at the vertical plate 23 and the horizontal plate 25.

The coupling part 15 of the mounting bracket 17 is bolted to the transmission 21 via a plurality of bolts. The transmission 21 bolted with the mounting bracket 17 is placed inside the engine room, then the mount 7 is placed between the vertical walls 11 of the mounting bracket 17, as shown in the right side view of FIG. 2. The bolt 13 is fastened through the vertical walls 11 and the mount 7 in a state of insulated vibration. Thus, the transmission 21 is completely mounted to the car body via the mount 7.

The mounting structure of a vehicle is thus configured by way of fixing the chassis bracket 9 integrated with the mount 7 to the side frame 19, and coupling the mount-chassis bracket assembly via the bolt 13 to the mounting bracket 17 secured to the transmission 21, thereby providing a simplified and feasible structure.

The mounting bracket 17, integrally coupled with vertical walls 11 encompassing the mount 7, allows the broad flat surface of the coupling part 15 to be coupled tightly to the transmission 21 for strengthening the connecting force and rigidity. In particular, the broad installation surface of the coupling part 15 enhances the rigidity of the forward and rearward direction of the vehicle.

The chassis bracket 9 integrated with the mount 7 is attached to the side frame 19 in a vertical as well as horizontal surface. The chassis bracket 9 is also formed with a reinforcing rib 27 and bent part 29 to provide a strong connecting force and rigidity.

Thus, the mounting structure according to the present invention provides a strengthened connecting force and rigidity, and effectively isolates various noise and vibration generated from the transmission 21.

According to experiments, the mounting structure thus described can effectively reduce noise of about 3˜5 KHz which is generated by friction between the tooth difference in the transmission 21 that would otherwise be transmitted inside the vehicle while a vehicle is in motion.

As apparent from the foregoing, there is an advantage in a mounting structure of a vehicle in that the structure is simplified and firmly and stably supports an engine or a transmission at a lateral side of an engine room.

There is another advantage in that the mounting structure effectively isolates vibration from an engine or a transmission to a car body.

What is claimed is:

1. A mounting structure for a vehicle, comprising:
a mount having a vibration insulating member made of a rubber material between an inner pipe and an outer pipe;
a chassis bracket coupled to said outer pipe for attaching said mount to a lateral side of an engine room to allow a longitudinal direction of said inner pipe and said outer pipe to correspond with a forward and rearward direction of the vehicle; and
a mounting bracket for providing vertical walls in the forward and rearward direction of said mount of the car body to be connected with said mount via a bolt which passes through said vertical walls and said inner pipe, wherein a coupling part connected to said vertical walls is configured for attachment to a heavy component of the vehicle.

2. The mounting structure as defined in claim 1, wherein said chassis bracket comprises:
a vertical plate formed with a vertical surface for being closely attached to said lateral side of the engine room, and formed with bolt holes; and
a horizontal plate horizontally formed for attachment to said lateral side of the engine room, and formed with bolt holes.

3. The mounting structure as defined in claim 1, wherein said mounting bracket comprises:
a vertical wall connector for connecting said vertical walls; and
said coupling part formed with a horizontal plate for coupling the bottom of said vertical walls and said vertical wall connector as one flat surface, and formed with a plurality of bolt holes.
